(19) United States
(12) Patent Application Publication
(10) Pub. No.: US 2025/0124258 A1
(43) Pub. Date: Apr. 17, 2025

(54) SYSTEM AND METHOD FOR CONSISTENT CONTENT CATEGORIZATION VIA CONSISTENT SELF-TRAINING

(71) Applicant: YAHOO ASSETS LLC, New York, NY (US)

(72) Inventors: Ariel Raviv, Haifa (IL); Noa Avigdor-Elgrabli, New York, NY (US); Stav Yanovsky Daye, New York, NY (US); Michael Viderman, Haifa (IL); Guy Horowitz, New York, NY (US)

(21) Appl. No.: 18/487,487

(22) Filed: Oct. 16, 2023

(51) Int. Cl. G06N 3/0455; G06N 3/0895

(52) U.S. Cl. CPC G06N 3/0455; G06N 3/0895

(57) ABSTRACT

The present teaching relates to content categorization. Supervised training data and unlabeled data clusters are used to generate augmented training data. Each unlabeled data cluster includes data samples with varying features. Weakly labeled training data is created based on supervised training data and the unlabeled data clusters with data samples therein with cluster labels via consistent self-training so that a labeled data sample in the supervised training data and a data sample in the weakly labeled training data with the same label have varying characteristics. Augmented training data is created from the supervised and the weakly labeled training data and is used to train a robust content categorization model via machine learning.

### CROSS REFERENCE TO RELATED APPLICATION

The present application is related to U.S. patent application Ser. No. ______ (Attorney Docket No.: 146555.583326), titled “SYSTEM AND METHOD FOR CONSISTENT CONTENT CATEGORIZATION VIA GENERATIVE AI”, filed Oct. 16, 2023, the contents of which are hereby incorporated by reference in its entirety.

### BACKGROUND

### 1. Technical Field

The present teaching generally relates to electronic content. More specifically, the present teaching relates to content processing.

### 2. Technical Background

With the development of the Internet and the ubiquitous network connections, more and more commercial and social activities are conducted online. Networked content is served to millions, some requested and some recommended. Such online content includes information such as publications, articles, and communications as well as advertisements. Online platforms that make electronic content available to users leverage the opportunities to interact with users to provide content of users' likings to maximize the monetization online platforms. To do so, an important task is to categorize online content accurately to match the content with what a user desires or likes. For example, e-commerce platforms (e.g., Amazon or eBay) categorize a massive amount of product information for both sale and business studies. Such platforms rely on both explicit and implicit product features in order to deliver satisfying user experience. The inferred product category is usually a crucial indication for many online applications such as browsers, search engines, or recommender systems.

Some systems perform daily fast categorization of billions of items by, e.g., classifying e-commerce items, such as products or deals, based on, e.g., a predefined product taxonomy. Input text associated with a product or a deal may be provided based on which a category label is obtained. In FIG. 1, a conventional system 100 is illustrated, where a text feature extractor 110 may process input text characterizing a product to generate feature vectors, which may then be used by a text categorization engine 120 to categorize, based on text categorization models 130, the product represented by the input text to produce a category. In some systems, the text feature extraction and categorization may be merged into one categorizer that produces a category from the input text.

Given a product title, a categorizer assigns the most appropriate label from the taxonomy to the product. In e-commerce, many products may have or be described with different variations. For example, the same product may be given different product titles. A product may have different versions each having some slightly changes features such as colors or measurements. In some situations, such small variations often significantly affect the categorizer's output, causing inconsistent categorization, which negatively impacts the downstream applications, e.g., in search engine and recommender systems, that rely on the inferred category. As such, inconsistent categorization leads to unsatisfactory user experiences.

Thus, there is a need for a solution that can tackle the issue of the traditional approaches to enhance the performance of information categorization.

### SUMMARY

The teachings disclosed herein relate to methods, systems, and programming for information management. More particularly, the present teaching relates to methods, systems, and programming related to content processing and categorization.

In one example, a method, implemented on a machine having at least one processor, storage, and a communication platform capable of connecting to a network for content categorization. Supervised training data and unlabeled data clusters are used to generate augmented training data. Each unlabeled data cluster includes data samples with varying features. Weakly labeled training data is created based on supervised training data and the unlabeled data clusters with data samples therein with cluster labels via consistent self-training so that a labeled data sample in the supervised training data and a data sample in the weakly labeled training data with the same label have varying characteristics. Augmented training data is created from the supervised and the weakly labeled training data and is used to train a robust content categorization model via machine learning.

In a different example, a system is disclosed for displaying ads that includes a training data augmenter and an augmented data-based model training engine. The training data augmenter is provided for receiving supervised training data and unlabeled data clusters, that are used to generate weakly labeled training data. The supervised training data include data samples each having a label from multiple labels and each unlabeled data cluster includes multiple unlabeled data samples with varying features. The weakly labeled training data includes data samples each being assigned with one of the multiple labels via consistent self-training so that a data sample in the supervised training data with a label and a data sample from the weakly labeled training data with the same label have varying characteristics. The augmented data-based model training engine is for obtaining augmented training data based on the supervised training data and the weakly labeled training data and training a robust content categorization model based on the augmented training data via machine learning.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for content categorization. The recorded information, when read by the machine, causes the machine to perform various steps. Supervised training data and unlabeled data clusters are used to generate augmented training data. Each unlabeled data cluster includes data samples with varying features. Weakly labeled training data is created based on supervised training data and the unlabeled data clusters with data samples therein with cluster labels via consistent self-training so that a labeled data sample in the supervised training data and a data sample in the weakly labeled training data with the same label have varying characteristics. Augmented training data is created from the supervised and the weakly labeled training data and is used to train a robust content categorization model via machine learning.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a conventional text categorization system;

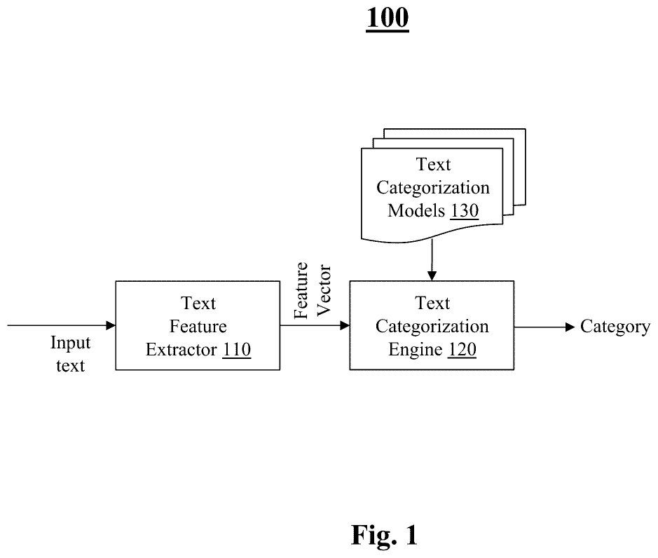

FIG. 2A depicts an exemplary high-level system diagram of a consistent text categorization framework based on augmented data created via generative AI, in accordance with an embodiment of the present teaching;

FIG. 2B provides exemplary types of sources from where unlabeled data clusters may be obtained;

FIG. 2C illustrates an exemplary construct of augmented training data including weakly labeled training data generated via consistent self-training (CST) or consistent generative augmentation (CGA), in accordance with an embodiment of the present teaching;

FIG. 2D is a flowchart of an exemplary process for a consistent text categorization framework based on augmented data created via CST or CGA, in accordance with an embodiment of the present teaching;

FIG. 3A depicts an exemplary high-level system diagram of a training data augmenter for augmenting supervised training data to include weakly labeled training data, in accordance with an embodiment of the present teaching;

FIG. 3B is a flowchart of an exemplary process for a training data augmenter for augmenting supervised training data to include weakly labeled training data, in accordance with an embodiment of the present teaching;

FIG. 4A depicts an exemplary high-level system diagram of a self-training data generator, in accordance with an embodiment of the present teaching;

FIG. 4B is a flowchart of an exemplary process of a self-training data generator, in accordance with an embodiment of the present teaching;

FIG. 5A depicts an exemplary high-level system diagram of generative augmentation generator, in accordance with an embodiment of the present teaching;

FIG. 5B is a flowchart of an exemplary process of a generative augmentation generator, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a framework for consistent content categorization by training robust categorization models based on augmented training data set that includes both supervised training data and weakly labeled training data derived from unlabeled data clusters based on the supervised training data. The aim is to augment the supervised training data to include those data that include variations of the same products that are included in the supervised training data. The variations are identified from unlabeled data clusters obtained dynamically and automatically from additional data sources.

To obtain unlabeled data clusters, mechanisms may be set up to acquire data from different sources such as crawling different websites, extracting information from commercial catalogs, or receiving from 3^{rd} party information dealers. The data acquired in this manner correspond to unlabeled data clusters, i.e., data samples acquired are in groups, each of which includes data samples of the same class with variations. The variations exhibited in each of the data clusters may be leveraged to enrich or augment the supervised training data. In some embodiments, with respect to each labeled data sample in the supervised training data, a set of additional data samples from one of the acquired data clusters may be identified as corresponding to the labeled data sample. In this case, the additional data samples from the unlabeled data cluster may be estimated to have the same label as that of the labeled data sample and may be weakly labeled as such. Each of the labeled data samples in the supervised training data and the corresponding weakly labeled additional data samples may form an augmented set of training data with the same label. Thus, the supervised training data and all the additional weakly labeled data samples may form augmented training data that incorporate variations for each class.

In some embodiments, additional data samples may also be created via generative AI to augment each of the labeled data samples in the supervised training data. Based on unlabeled data clusters, generative augmentation models may be trained based on unlabeled data clusters to learn variations exhibited in the unlabeled data clusters. Such learned generative augmentation models may then be applied to each of the labeled data samples in the supervised training data to generate additional data samples according to the knowledge on variations learned during the training. The generated data samples with respect to a labeled data sample may then be weakly labeled with the same label as the labeled data sample. Such weakly labeled additional data samples generated with respect to the supervised training data may then be used to augment or enrich the supervised training data to generate augmented training data.

The augmented training data may then be used to train content categorization models for categorizing input content. As the augmented training data incorporates, for each class, data with variations, the categorization models obtained based on the augmented training data learns to recognize variations and, thus, is capable of robustly categorizing input content consistently even when input content exhibits variations.

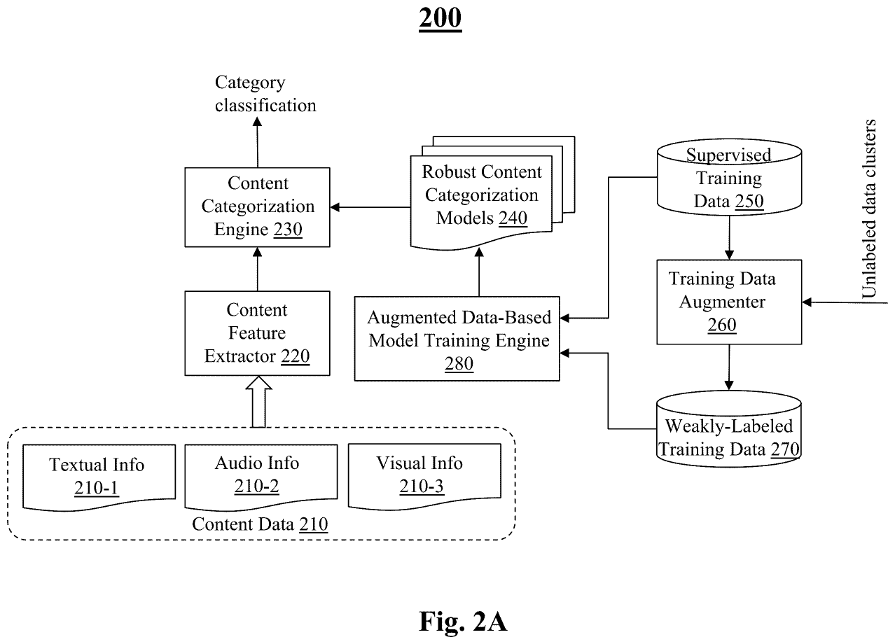

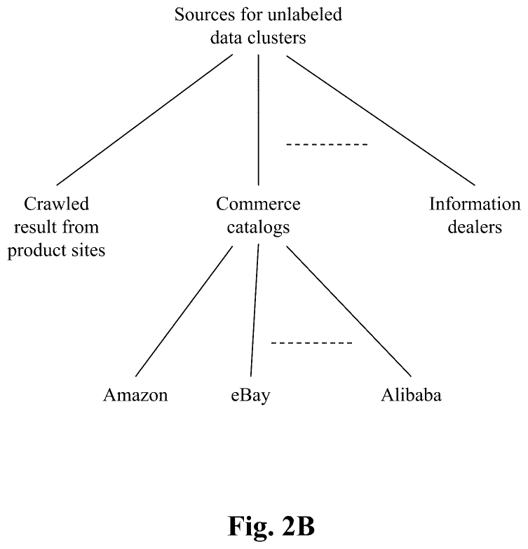

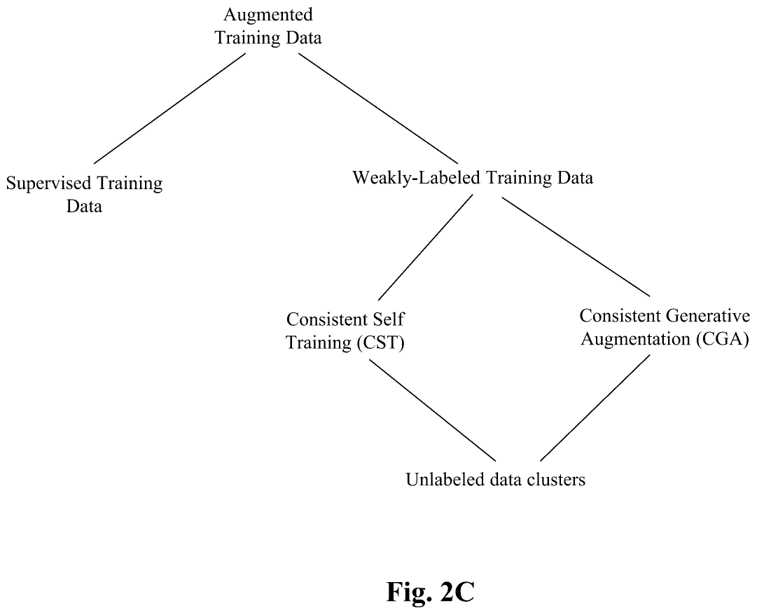

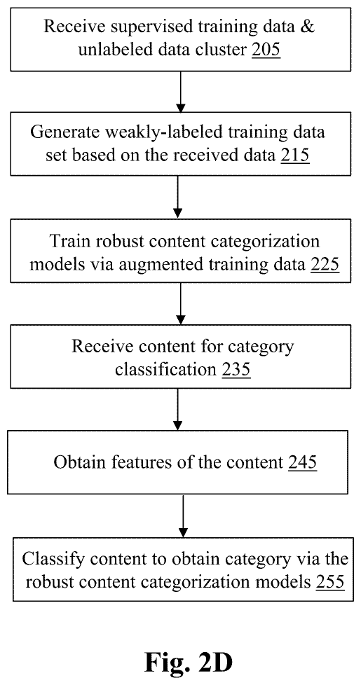

FIG. 2A depicts an exemplary high-level system diagram of a consistent text categorization framework 200 based on augmented training data, in accordance with an embodiment of the present teaching. In this illustrated framework 200, input content data 210 is categorized using a content categorization engine 230. In some embodiments, the content categorization engine 230 may perform categorization based on features extracted by a content feature extractor 220 from the given input content. In some embodiments, the content categorization may be performed based on the input content directly with feature extraction embedded in the categorization process as an integral part of content categorization (not shown). The input content 210 may correspond to textual information 210-1, audio information 210-2, visual information 210-3, or any combination thereof. The visual information 210-3 may include image information or video information. The content feature extractor 220, when present, may process the input content and extract features relevant to the subsequent categorization by the content categorization engine 230.

In this illustrated embodiment, the content categorization engine 230 performs the categorization using robust content categorization models 240, derived via machine learning by a model training engine 280 based on augmented training data obtained in accordance with the present teaching. The augmented training data is from two data sets, including the supervised training data 250 with labeled data samples as well as the weakly labeled training data 270. As discussed herein, the weakly labeled training data is generated based on unlabeled data clusters with respect to the supervised training data 250 by a training data augmenter 260. The unlabeled data clusters may be obtained dynamically and/or periodically from different sources. FIG. 2B provides exemplary types of sources from where unlabeled data clusters may be obtained. Such unlabeled data clusters may be crawled from different websites that post information on, e.g., products, to interested users. For example, brands such as Adidas, Hanes, Levis, Old Navy, Under Armour, etc. may provide their lines of products on their websites where each different clothing line may be described with different variations such as colors, sizes, etc. Each line of products with variations may be accessed as a cluster where all variations may all correspond to the same class.

Unlabeled data clusters may also be obtained from various commerce catalogs including, e.g., product catalogs. In an online world, there are numerous digital e-catalogs or web-catalogs that are readily accessible by the public or interested parties electronically. Sources for such web-accessible catalogs include Amazon, eBay, Alibaba and the likes. From such sources, products have been clustered for their respective business operations and may be utilized to enrich the supervised training data 250 to include variations for each class of product. In some situations, unlabeled data clusters may also be obtained from other sources such as information dealers who may gather, e.g., product categories and sell such information. Although some data clusters obtained from available sources may be labeled at their sources, such data is utilized to the extent that they form clusters without cluster labels in the context of the present teaching.

As discussed herein, the unlabeled data clusters are obtained for augmenting the supervised training data 250 so that each of the classes in the supervised training data may be enriched or augmented with data for training that present adequate variations in each class estimated according to actual product varieties available. FIG. 2C illustrates an exemplary construct of augmented training data set, in accordance with an embodiment of the present teaching. As shown in FIG. 2C, the augmented training data according to the present teaching may be created by combining the supervised training data with weakly labeled training data, which may be generated based on the unlabeled data clusters via consistent self-training (CST), consistent generative augmentation (CGA), or a combination thereof.

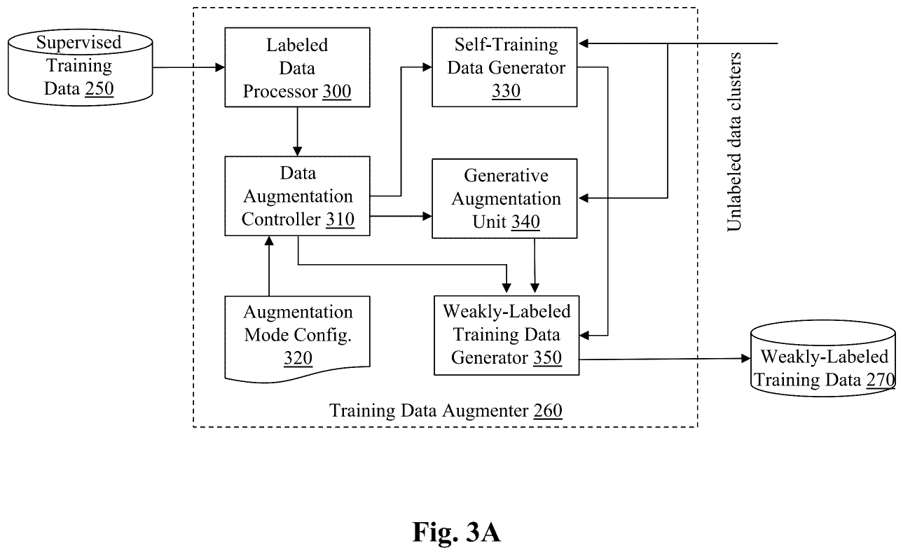

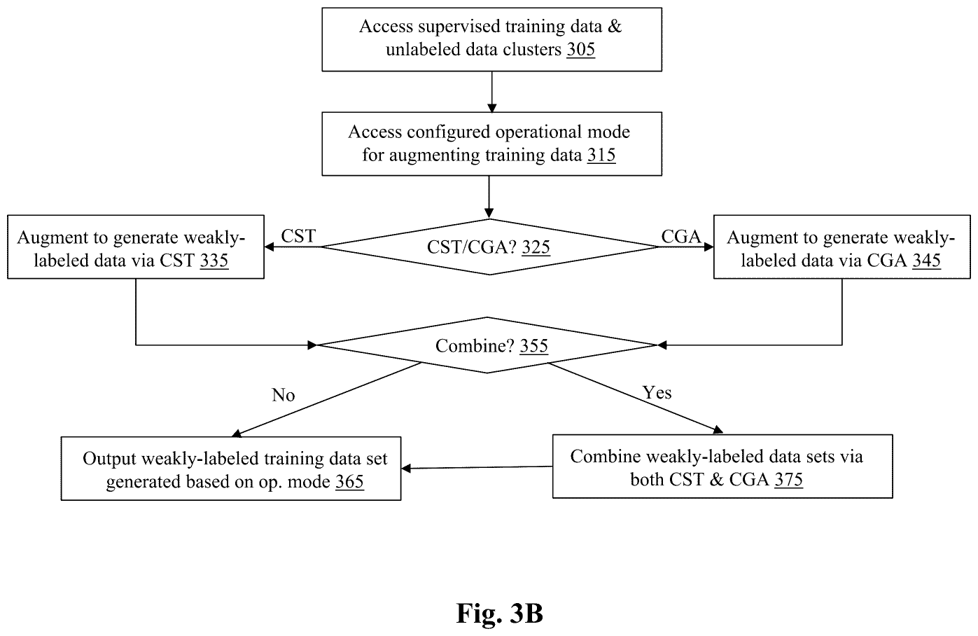

FIG. 2D is a flowchart of an exemplary process for the consistent text categorization framework 200, in accordance with an embodiment of the present teaching. To train the robust content categorization models 240, supervised training data and unlabeled data clusters are received at 205 and used to generate, at 215 by the training data augmenter 260, weakly labeled training data. Details about generating the weakly labeled training data will be provided in reference to FIGS. 3A-5B. The supervised training data 250 and the weakly labeled training data 260 together form the augmented training data, which is then used to train, at 225 by the model training engine 280, the robust content categorization models 240. With the trained robust content categorization models 240, when input content 210 is received at 235, the content feature extractor 220 obtains, at 245, features of the input content and provides the features to the content categorization engine 230. Based on the received features of the input content, the content categorization engine 230 classifies, at 255, the input content into a category based on the robust content categorization models 240. As discussed herein, in some embodiments (not shown), the feature extraction and classification may be merged as a one phase operation. Such a merged operation may also be conducted in accordance with the robust content categorization models 240.

FIG. 3A depicts an exemplary high-level system diagram of the training data augmenter 260 for generating weakly labeled training data 260, in accordance with an embodiment of the present teaching. As discussed herein, the weakly labeled training data 260 may be generated based on the supervised training data 250 as well as the unlabeled data clusters, which is illustrated in FIG. 3A. The training data augmenter 260 in this illustrated embodiment includes a labeled data processor 300, a data augmentation controller 310, a self-training data generator 330, a generative augmentation unit 340, and a weakly labeled training data generator 350. The labeled data processor 300 may be provided to preprocessing each of the data samples from the supervised training data 250 for further operation to generate weakly labeled training data related thereto. The data augmentation controller 310 is provided for controlling the operation of generating the weakly labeled training data according to the configured augmentation mode in 320. As discussed herein, the weakly labeled training data according to the present teaching may be generated in different operational modes, including in a self-training mode, in a generative augmentation mode, or in a combined mode where weakly labeled data sets generated respectively via self-training mode and generative augmentation mode may be combined to generate the weakly labeled training data 260.

The self-training data generator 330 may be provided for generating a weakly labeled data set based on data samples from the supervised training data 250 and the unlabeled data clusters. The self-training data generator 330 generates a weakly labeled data set by using content self-training of given unlabeled data clusters. It may be invoked by the data augmentation controller 310 when the augmentation mode configured in 320 is either the CST mode (for self-training mode) or a combined mode (combine self-training mode result with CGA result). Similarly, the generative augmentation unit 340 may be provided for creating a weakly labeled data set based on the supervised training data 250 as well as the obtained unlabeled data clusters. The generative augmentation unit 340 may create a weakly labeled data set based on supervised training data samples via generative AI models that are trained via learning from the input unlabeled data clusters. The generative augmentation unit 340 may be invoked by the data augmentation controller 310 when the augmentation mode configured in 320 is either the CGA mode (for a generative augmentation model) or a combined mode (combine the CGA augmentation result with that from a self-training mode).

The weakly labeled training data generator 350 may be provided to generate the weakly labeled training data 270 in accordance with the control signals from the data augmentation controller 310. If the configured mode of operation is CST, the weakly labeled training data generator 350 receives the weakly labeled data set generated by the self-training data generator 330 and outputs it as the weakly labeled training data in 270. If the configured mode of operation in 320 is CGA and signaled as such by the data augmentation controller 310, the weakly labeled training data generator 350 receives the weakly labeled data set created by the generative augmentation unit 340 and saves it in the weakly labeled training data storage 270 as the additional training data created. If the configured mode of operation in 320 is to combine the weakly labeled data sets from both CST and CGA, the weakly labeled training data generator 350 receives the weakly labeled data sets from both the self-training data generator 330 and the generative augmentation unit 340, combines them to generate a combined set, and saves the combined set in the weakly labeled training data storage 270.

FIG. 3B is a flowchart of an exemplary process for the training data augmenter 260 for augmenting supervised training data to create weakly labeled training data, in accordance with an embodiment of the present teaching. Upon receiving the supervised training data 250 and unlabeled data clusters at 305, the data augmentation controller 310 accesses, at 315, the configured mode of operation stored in 320 and controls the operation accordingly. If the mode of operation is CST, determined at 325, the self-training data generator 330 is invoked to augment, at 335, the supervised training data 250 to generate CST weakly labeled data set. If the mode of operation is CGA, determined at 325, the generative augmentation unit 340 is invoked to augment, at 345, the supervised training data 250 to generate CGA weakly labeled data set. If the mode of operation is either merely CST or CGA (without combination), determined at 355, the weakly labeled data set, generated via either CST or CGA, is used as the generated weakly labeled training data by the augmented training data generator 350 as the output, at 365, to the weakly labeled training data storage 270. If the mode of operation indicates to combine, determined at 355, the augmented training data generator 350 combines, at 375, the weakly labeled data sets generated respectively via CST and CGA to generate a combined set as the weakly labeled training data and output it, at 365, to the weakly labeled training data storage 270.

As discussed herein, the supervised training data 250 was augmented to include also weakly labeled training data 270. As the weakly labeled training data is generated based on unlabeled data clusters based on learning, the augmented training data, which includes the supervised training data 250 and the weakly labeled training data 270, corresponds to semi-supervised training data. The augmented training data is then used, as shown in FIG. 2A, by the model training engine 280 to train the robust content categorization models 240. In other words, the augmented training data enables consistent semi-supervised learning (SSL) to derive the robust content categorization models 240. This consistent categorization or classification enabled by consistent SSL via augmenting the supervised training data according to the present teaching may be formalized as follows.

Let X be a set of items for categorization, and Y=[c] for cϵN, be a final set of labels. Each item x∈X corresponds to a label y E Y. Also let V: X→X, be a nondeterministic perturbation function which may transform an item from one version x to another version \hat{x}. For example, if x “blue T-shirt small size”, V(x)=\hat{x}, where \hat{x} may be “black T-shirt small size” or “blue T-shirt large size.” Assume that the perturbation function is label-preserving, i.e. x, \hat{x}˜V(x) share the same label y. Let p(x,y) be a joint distribution over items and labels and p(x) be the marginal distribution over items. The goal of consistent categorization is to learn a classifier ƒ: X→X from a class F with a dual objective: (1) a high expected accuracy, i.e., a high expected value of an indicator that an item x∈X is labeled by ƒ to its correct label y:

$$\begin{matrix}E ( x , y ) ∼ p ( x , y ) & [ l \{ f ( x ) = y \} ]\end{matrix} \qquad ( 1 )$$

and (2) a high expected consistency, which may be defined as:

$$\begin{matrix}E x ∼ p ( x ) \hat{x} ∼ V ( x ) & [ l \{ f ( x ) = f ( \hat{x} ) \} ]\end{matrix} \qquad ( 2 )$$

i.e., the expected value of the indicator of two items x, \hat{x}˜V(x) to be transformed by ƒ to the same label. Therefore, the dual objective of ƒ can be formalized as:

$$\begin{matrix}min f E ( x , y ) ∼ p ( x , y ) , \hat{x} ∼ V ( x ) & [ [ l \{ f ( x ) \neq y \} + λl \{ f ( x ) \neq f ( \hat{x} ) \} ] ]\end{matrix} \qquad ( 3 )$$

where λϵR controlling the balance between the accuracy loss and the consistency loss. There may be a trade-off in the dual objective between accuracy and consistency. A model trained to disregard specific features such as color or size may be more consistent. But because such features may be informative in partitioning some categories, ignoring these features may negatively impact the overall accuracy. For example, the color purple may be more likely to appear in sports shoes than in evening shoes. A model that is trained to give less weight to colors may be more robust to changes in colors and thus more consistent. In the meantime, the same model may be less accurate when it comes to distinguishing between sports and evening shoes.

In a conventional SSL setting, given labeled data D_{L}={(x₁,yᵢ)}l i=1, which is assumed to be sampled from an independently and identically distributed (i.i.d.) data set p, and unlabeled data D_{U}={xᵢ}l+u i=l+1 which may be sampled from another distribution q. A classifier ƒ may then be tuned based on D_{L} and D_{U}. While the consistent SSL according to the present teaching, the unlabeled data D_{U} corresponds to data clusters that are clustered with respect to a perturbation function V, i.e. it includes v sets of items Xᵢ, each set contains kᵢ versions \hat{x}(i)j˜V(xᵢ) of the same item xᵢ. More formally, D_{U}={xᵢ}l+u i=l+1, where, Xᵢ={x(i)j}ⱼ₌₁^{k}^{ᵢ}, and \hat{x}ⱼ⁽ⁱ⁾˜V(xᵢ) for j=1 . . . kᵢ. Given this formulation, the aim of consistent-SSL according to the present teaching is to learn a classifier ƒ or a robust categorization model that optimizes the objective function in Eq. (3) given D_{L} and D_{U}. In the framework discussed herein, the function V is not known but is implicitly and indirectly represented in the unlabeled data clusters or the D_{U} samples.

As discussed herein, two exemplary approaches to augment the supervised training data based on weakly labeled training data. One is via consistent self-training or CST and the other via consistent generative augmentation (CGA). Both CST and CGA may utilize the unlabeled data clusters in D_{U} for data augmentation. Both CST and CGA are provided to create an augmented data set D_{aug} (corresponding to weakly labeled training data 270) using D_{U} and then train the robust content categorization models 240 based on D_{L}∪D_{aug}. Such obtained robust content categorization models 240 may then be used, by the content categorization engine 230 for content categorization. With the augmented weakly labeled training data D_{aug} with different versions of the same items, the optimization of the objective function as defined via Eq. (3) facilitates the training of the robust content categorization models 240 to learn the variations included in the augmented training data, and thus, achieving the goal of exposing the content categorization models and classification function ƒ to a more diverse set of item versions in training time, making it more robust to minor changes.

An example is provided below to illustrate the concept. Consider a dataset that contains clothing items. Assuming that supervised training data 250 with labeled samples, or D_{L}, is sampled from a distribution p and exhibits a spurious correlation between a feature, e.g., color of an item, to its category (e.g., most of the black items are coats and most of the red items are dresses). A classifier trained based solely on D_{L} will likely rely on the color of an item to predict the category of the item. That is, a classifier trained solely on D_{L} will not be consistent. When the training data used to train a content categorization model includes items (e.g., coat) of multiple colors (e.g., black, red, blue, etc.) with the same label (e.g., coat), then the model trained on such data may not view a specific color as determinant with respect to a specific label and instead, likely may ignore the color feature of an item when it predicts the label for the item and will thus be more robust to changes in color. The color feature used in this example is merely for illustrating the concept and it is not intended as a limitation to the scope of the present teaching. Any other features associated with any items may also be treated as spurious features such as measurements, models, materials, manufacturers, etc.

Formally, weakly labeled data samples D_{aug} generated based on CST may be generated based on unlabeled data clusters D_{U} and added to the supervised training data 250 or D_{L} to generate an augmented training data set for training the robust content categorization models 240. As the data samples in D_{U} are unlabeled, to make sure that the weakly labeled training data 270 or D_{aug} is consistent, it is important that each item set Xᵢ is assigned with the same pseudo-label \tilde{y}ᵢ. To calculate \tilde{y}ᵢ, a base model ƒ^{base} may first be trained using the supervised training data D_{L} and then be used to choose a single pseudo-label for each example set Xᵢ, i.e. \tilde{y}ᵢ←h(Xᵢ;ƒ^{base}) where h is a function that, given a set of examples and a classifier ƒ^{base}, returns a single label. For example, h may return the prediction of ƒ^{base} that got the highest confidence score, or the most frequent prediction across Xᵢ. In some embodiments, function h may correspond to a hyperparameter of the approach. Upon generating the weakly labeled training data D_{aug} from D_{U}, the robust content categorization models 240 may then be trained over the augmented training data D_{L}∪D_{aug}.

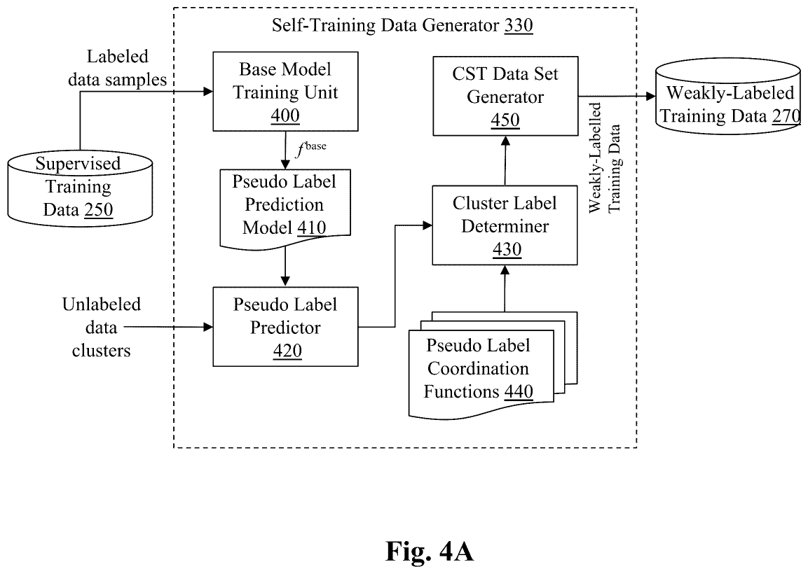

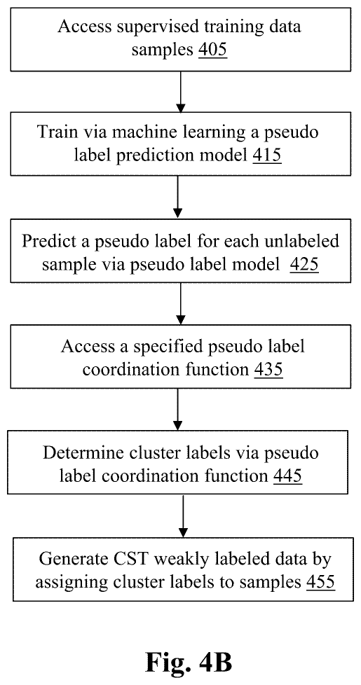

FIG. 4A depicts an exemplary high-level system diagram as an implementation of the self-training data generator 330, in accordance with an embodiment of the present teaching. In this illustrated embodiment, the self-training data generator 330 comprises a base model training unit 400, a pseudo label predictor 420, a cluster label determiner 430, and a CST data set generator 450. The base model training unit 400 may be provided for training base model ƒ^{base} as a base pseudo label prediction model 410. As discussed herein, the training of this base model ƒ^{base} is based on the supervised training data 250 or D_{L}. With the base pseudo label prediction model 410 available, the pseudo label predictor 420 is provided for predicting a pseudo labels for each of the data samples included in the unlabeled data clusters D_{U} in accordance with the base pseudo label prediction model 410 or ƒ^{base}. In some embodiments, each of the predicted labels for an unlabeled data sample may be associated with a confidence score.

Such predicted pseudo labels for the unlabeled data samples are then provided to the cluster label determiner 430, which is provided to determine, for each of the data clusters in the unlabeled data set D_{U} a label based on a pseudo label coordination function h specified in 440. In this manner, each of the data clusters in D_{U} may then have a single assigned label. Such weakly labeled data clusters are then provided to the CST data set generator 450 where the weakly labeled data clusters are integrated as the output D_{aug} from the self-training data generator 450. In some embodiments, the pseudo label coordination function h used to determine a single label for each data cluster in D_{U} may be defined to select a predicted label that has the maximum confidence score. In some embodiments, function h may be defined to select a label that exhibits the highest level of occurrence (or frequency) across the data samples in a cluster. Through the pseudo label coordination function h, each of the data clusters in D_{U} may have a coordinated predicted label.

FIG. 4B is a flowchart of an exemplary process of the self-training data generator 330, in accordance with an embodiment of the present teaching. To train the base pseudo label prediction model ƒ^{base}, the base model training unit 400 accesses, at 405, the supervised training data 250 or D_{L} and trains, at 415, the base model ƒ^{base} via machine learning based on D_{L} to obtain the pseudo label prediction model 410 or ƒ^{base}. The self-trained pseudo label prediction model ƒ^{base} is then used, by the pseudo label predictor 420 to predict, at 425, a pseudo label for each of the unlabeled data samples in D_{U}. With respect to data samples in each of the unlabeled data clusters, the cluster label determiner 430 accesses, at 435, a specified pseudo label coordination function h in order to determine accordingly a single cluster label for each of the unlabeled data clusters based on the predicted pseudo labels predicted for the data samples therein. Based on the weakly labeled data clusters created according to the present teaching, the CST data set generator 450 may then generate the CST weakly labeled training data set D_{aug} and save it in the weakly labeled training data storage 270.

As discussed herein, in a different mode of operation, the weakly labeled training data may be created based on the supervised training data D_{L} as well as the unlabeled data clusters D_{U} via CGA. Formally, to create augmented trained data with more variations for each of classes, a generative model M may first be trained based on unlabeled data clusters D_{U} to learn a perturbation function V, which may then be used to generate new data samples for each of the data samples in supervised training data D_{L}. In some embodiments, an item-pair dataset of different versions of items, denoted as Dₚₐᵢᵣₛ, may be constructed from D_{U} as:

$${D}_{pairs} = \{ \hat{x} ( i ) j , {\hat{x}}_{j}^{( i )} \vert l + 1 \leq i \leq l + u ∧ j , {j}^{′} ∈ [ {k}_{i} ] \} ,$$

where the two items in each pair have the same label. The generative model M may be trained based on Dₚₐᵢᵣₛ. The trained generative model M learns to generate a second item given a first item in each pair, while maintaining its label. It is noted that \hat{x}_{j′}⁽ⁱ⁾˜V(\hat{x}_{j′}⁽ⁱ⁾).

As such, the generative model M may then be applied to each labeled data sample (x,y)∈D_{L}, where x corresponds to a data sample and y corresponds to the known label of x, to generate an augmentation set D_{aug} with one or more new labeled samples (x,y), where \hat{x} represents a new data sample generated by the generative model M that has label y. In some embodiments, the D_{aug} created via CGA may be filtered via, e.g., a score function s: X×X→[0,1] that may be provided to measure the quality of the generated x with respect to its origin x. In some embodiments, the score function may be specified to represent, e.g., similarity between \hat{x} and its origin x. Some generated samples x may be filtered out from D_{aug} according to some predefined filtering criterion such as a threshold.

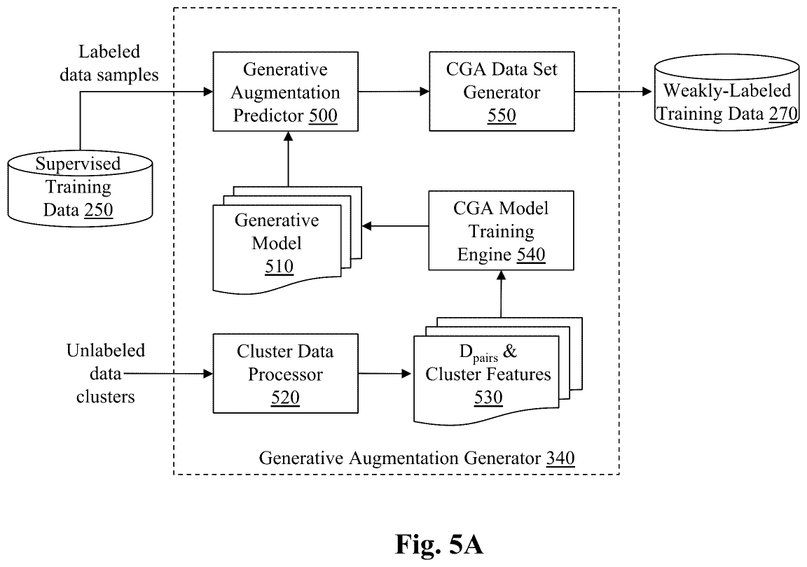

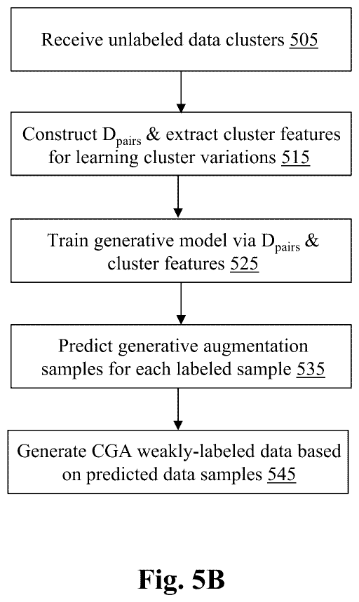

FIG. 5A depicts an exemplary high-level system diagram of the generative augmentation generator 340, in accordance with an embodiment of the present teaching. In this illustrated embodiment, the generative augmentation generator 3430 includes a cluster data processor 520, a CGA model training engine 540, a generative augmentation predictor 500, and a CGA data set generator 550. As discussed herein, the CGA mode of operation starts with training a generative model M to learn the variations within clusters. The cluster data processor 520 may be provided to access the unlabeled data clusters D_{U} and construct Dₚₐᵢᵣₛ as discussed herein and features associated thereof. Such constructed item pairs Dₚₐᵢᵣₛ may then be used, e.g., with the associated cluster features, by the CGA model training engine 540 to train, via machine learning, the generative model M 510, which learns, during training, the perturbation within different clusters under each of the labels.

Such trained generative model M 510 may be capable of creating new data samples under each label according to the variations within each cluster learned during the training and may be utilized by the generative augmentation predictor 500 to generate, with respect to each of the labeled data sample (x,y)∈D_{L}, one or more varying new data samples with perturbed features in a manner as learned from data clusters in D_{U}. The number of new data samples generated via generative model M 510 with respect to each labeled data sample (x,y)∈D_{L} may be configured as a system parameter which may be determined according to the need of an application. The CGA data set generator 550 is provided to generate weakly labeled training data D_{aug} based on the generated new samples (x,y) with the labels y inherited from the original data samples (x,y)∈D_{L} from the supervised training data.

FIG. 5B is a flowchart of an exemplary process of the generative augmentation generator 340, in accordance with an embodiment of the present teaching. The cluster data processor 520 receives, at 505, the unlabeled data clusters in D_{U} to generate item pairs Dₚₐᵢᵣₛ as training data to learn class variations. In some embodiments, certain features associated with different clusters may also be generated at 515. The CGA mode training engine 540 may use the Dₚₐᵢᵣₛ and optionally cluster features as training data to train, at 525, the generative model M 510 to learn perturbation patterns with respect to different clusters. The generative augmentation predictor 500 may then use the generative model M 510 to generate or predict, at 535, new varying samples x according to the learned perturbation with respect to each labeled data sample (x,y) from the supervised training data 250 or D_{L} with the same label y. Such augmented new data samples have weak labels because their labels are inherited from that of the supervised data samples. The new data samples with their weak labels may then be used by the CGA data set generator 550 to generate, at 545, the CGA weakly labeled training data D_{aug}.

As discussed herein, the D_{aug}, whether generated via CST, CGA, or in combination, may then be used, together with the supervised training data 250 or D_{L}, to form the enriched training data D_{L}∪D_{aug} for training the robust content categorization models 240 to achieve consistent content categorization via consistent SSL.

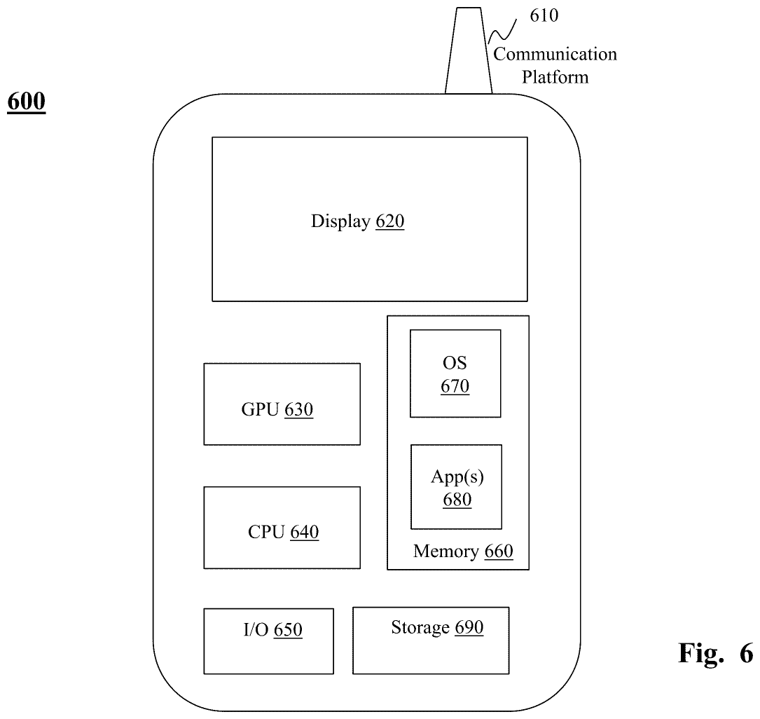

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

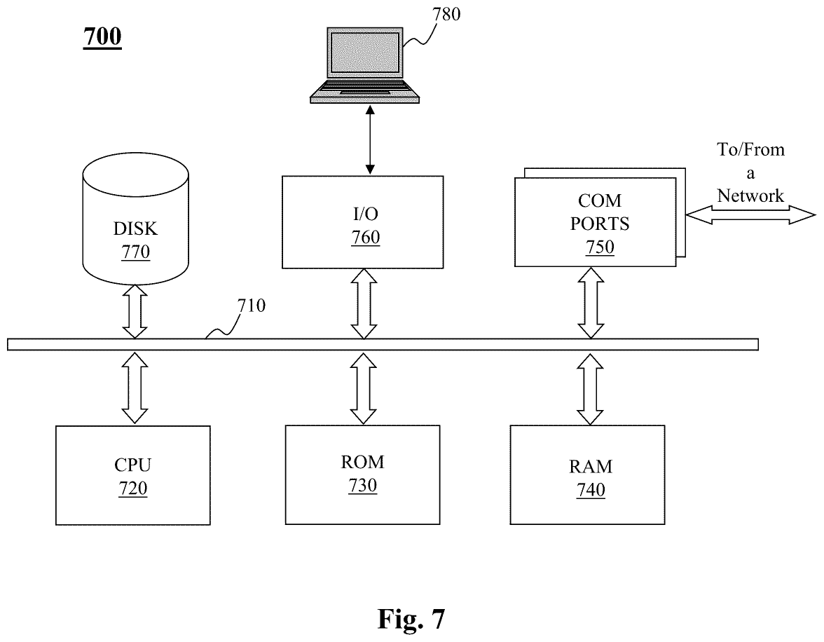

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
receiving supervised training data and unlabeled data clusters, wherein the supervised training data include data samples each of which has a label from a plurality of labels and each of the unlabeled data clusters includes multiple unlabeled data samples with varying features;
generating weakly labeled training data based on the supervised training data and the unlabeled data clusters, wherein the weakly labeled training data includes data samples each of which is assigned with one of the plurality of labels via consistent self-training so that a data sample in the supervised training data with a label and a data sample from the weakly labeled training data with the same label have varying characteristics;
obtaining augmented training data based on the supervised training data and the weakly labeled training data; and
training, via machine learning, a robust content categorization model based on the augmented training data.

2. The method of claim 1, wherein the generating the weakly labeled training data comprises:
training, via machine learning, a base pseudo label prediction model based on the supervised training data; and
creating the weakly labeled training data based on the unlabeled data clusters and the base pseudo label prediction model.

3. The method of claim 2, wherein the creating comprises:
for each of the unlabeled data clusters,
predicting, for each unlabeled data sample in the unlabeled data cluster, a pseudo label based on the base pseudo label prediction model, wherein the predicted pseudo label is one of the plurality of labels,
determining a cluster label for the unlabeled data cluster based on the pseudo labels predicted respectively for the unlabeled data samples in the unlabeled data cluster, wherein the cluster label if one of the plurality of labels, and
assigning the cluster label to each of the unlabeled data samples in the unlabeled data cluster; and
generating, based on the data samples in the unlabeled data clusters with newly assigned cluster labels, the weakly labeled training data.

4. The method of claim 3, wherein the determining a cluster label for the unlabeled data cluster comprises:
processing the pseudo labels predicted for the unlabeled data samples in the unlabeled data cluster;
obtaining at least one metric associated with the pseudo labels for data samples in the unlabeled data cluster; and
selecting one of the pseudo labels as the cluster label according to a predetermined function based on the at least one metric.

5. The method of claim 4, wherein
the at least one metric includes
a confidence score for each of the pseudo labels, or
a frequency for each of the pseudo labels.

6. The method of claim 4, wherein
the predetermined function is used for identifying the cluster label based on one of the pseudo labels that
has a maximum confidence score, or
is associated with a highest frequency.

7. The method of claim 1, further comprising:
receiving content to be categorized; and
classifying the content based on the robust content categorization model trained based on the augmented training data including both the supervised training data and the weakly labeled training data.

8. A machine-readable and non-transitory medium having information recorded thereon, wherein the information, when read by the machine, causes the machine to perform the following steps:
receiving supervised training data and unlabeled data clusters, wherein the supervised training data include data samples each of which has a label from a plurality of labels and each of the unlabeled data clusters includes multiple unlabeled data samples with varying features;
generating weakly labeled training data based on the supervised training data and the unlabeled data clusters, wherein the weakly labeled training data includes data samples each of which is assigned with one of the plurality of labels via consistent self-training so that a data sample in the supervised training data with a label and a data sample from the weakly labeled training data with the same label have varying characteristics;
obtaining augmented training data based on the supervised training data and the weakly labeled training data; and
training, via machine learning, a robust content categorization model based on the augmented training data.

9. The medium of claim 8, wherein the generating the weakly labeled training data comprises:
training, via machine learning, a base pseudo label prediction model based on the supervised training data; and
creating the weakly labeled training data based on the unlabeled data clusters and the base pseudo label prediction model.

10. The method of claim 9, wherein the creating comprises:
for each of the unlabeled data clusters,
predicting, for each unlabeled data sample in the unlabeled data cluster, a pseudo label based on the base pseudo label prediction model, wherein the predicted pseudo label is one of the plurality of labels,
determining a cluster label for the unlabeled data cluster based on the pseudo labels predicted respectively for the unlabeled data samples in the unlabeled data cluster, wherein the cluster label if one of the plurality of labels, and
assigning the cluster label to each of the unlabeled data samples in the unlabeled data cluster; and
generating, based on the data samples in the unlabeled data clusters with newly assigned cluster labels, the weakly labeled training data.

11. The medium of claim 10, wherein the determining a cluster label for the unlabeled data cluster comprises:
processing the pseudo labels predicted for the unlabeled data samples in the unlabeled data cluster;
obtaining at least one metric associated with the pseudo labels for data samples in the unlabeled data cluster; and
selecting one of the pseudo labels as the cluster label according to a predetermined function based on the at least one metric.

12. The medium of claim 11, wherein
the at least one metric includes
a confidence score for each of the pseudo labels, or
a frequency for each of the pseudo labels.

13. The medium of claim 11, wherein
the predetermined function is used for identifying the cluster label based on one of the pseudo labels that
has a maximum confidence score, or
is associated with a highest frequency.

14. The medium of claim 8, wherein the information, when read by the machine, further causes the machine to perform the following steps:
receiving content to be categorized; and
classifying the content based on the robust content categorization model trained based on the augmented training data including both the supervised training data and the weakly labeled training data.

15. A system, comprising:
a training data augmenter implemented by a processor and configured for
receiving supervised training data and unlabeled data clusters, wherein the supervised training data include data samples each of which has a label from a plurality of labels and each of the unlabeled data clusters includes multiple unlabeled data samples with varying features,
generating weakly labeled training data based on the supervised training data and the unlabeled data clusters, wherein the weakly labeled training data includes data samples each of which is assigned with one of the plurality of labels via consistent self-training so that a data sample in the supervised training data with a label and a data sample from the weakly labeled training data with the same label have varying characteristics; and
an augmented data-based model training engine implemented by a processor and configured
obtaining augmented training data based on the supervised training data and the weakly labeled training data, and
training, via machine learning, a robust content categorization model based on the augmented training data.

16. The system of claim 15, wherein the generating the weakly labeled training data comprises:
training, via machine learning, a base pseudo label prediction model based on the supervised training data; and
creating the weakly labeled training data based on the unlabeled data clusters and the base pseudo label prediction model.

17. The system of claim 16, wherein the creating comprises:
for each of the unlabeled data clusters,
predicting, for each unlabeled data sample in the unlabeled data cluster, a pseudo label based on the base pseudo label prediction model, wherein the predicted pseudo label is one of the plurality of labels,
determining a cluster label for the unlabeled data cluster based on the pseudo labels predicted respectively for the unlabeled data samples in the unlabeled data cluster, wherein the cluster label if one of the plurality of labels, and
assigning the cluster label to each of the unlabeled data samples in the unlabeled data cluster; and
generating, based on the data samples in the unlabeled data clusters with newly assigned cluster labels, the weakly labeled training data.

18. The system of claim 17, wherein the determining a cluster label for the unlabeled data cluster comprises:
processing the pseudo labels predicted for the unlabeled data samples in the unlabeled data cluster;
obtaining at least one metric associated with the pseudo labels for data samples in the unlabeled data cluster; and
selecting one of the pseudo labels as the cluster label according to a predetermined function based on the at least one metric.

19. The system of claim 18, wherein
the at least one metric includes
a confidence score for each of the pseudo labels, or
a frequency for each of the pseudo labels; and
the predetermined function is used for identifying the cluster label based on one of the pseudo labels that
has a maximum confidence score, or
is associated with a highest frequency.

20. The system of claim 15, further comprising a content categorization engine implemented by a processor and configured for:
receiving content to be categorized; and
classifying the content based on the robust content categorization model trained based on the augmented training data including both the supervised training data and the weakly labeled training data.
